(19) United States
(12) Patent Application Publication
(10) Pub. No.: US 2010/0089371 A1
(43) Pub. Date: Apr. 15, 2010

(54) FORCED AIR INDUCTION SYSTEM FOR INTERNAL COMBUSTION ENGINE AND ABNORMALITY DIAGNOSIS METHOD FOR SAME SYSTEM

(75) Inventors: Daisuke Shibata, Shizuoka-ken (JP); Hiroshi Sawada, Shizuoka-ken (JP); Go Ohara, Tokyo-to (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/593,001

(22) PCT Filed: Mar. 25, 2008
(86) PCT No.: PCT/IB2008/000701

§ 371 Date: Sep. 25, 2009

(30) Foreign Application Priority Data
Mar. 26, 2007 (JP) 2007-079996

(51) Int. Cl. F02M 25/07; F02B 47/08

(52) U.S. Cl. 123/568.16; 123/568.21

(57) ABSTRACT

A forced air induction system for an internal combustion engine (1) has: a forced air induction device; an EGR valve (10) provided in an EGR passage (9) connecting an intake air passage (14) and an exhaust gas passage (6); and a diagnosis device (20) adapted to execute an abnormality diagnosis for the forced air induction device based on a deviation of the actual boost pressure at the forced air induction device from a target boost pressure. The diagnosis device inhibits execution of the abnormality diagnosis when the operation state of the EGR valve is out of a normal operation range specifically determined.

### BACKGROUND OF THE INVENTION

1. Field of the Invention

The invention relates to a forced air induction system for an internal combustion engine and an abnormality diagnosis method for the same system, and in particular to such a system and method that, in a system in which an EGR valve is provided in parallel with a forced air induction device, execute a diagnosis based on the operation state of the EGR valve.

2. Description of the Related Art

In an engine with a forced air induction device, if the boost pressure decreases due to an abnormality of the forced air induction device, it may lead to an increase in the exhaust emissions and to an acceleration failure. To cope with this, various devices and systems have been proposed which are capable of diagnosing whether the forced air induction device has an abnormality. Japanese Patent No. 3738604 describes a system that corrects the amount of control to the opening degree of an wastegate bypassing the turbine of the forced air induction device in accordance with the deviation of the actual boost pressure from a target boost pressure. This system determines the forced air induction device as having an abnormality when the control amount is at the lower limit level or the upper limit level and the deviation of the actual boost pressure from the target boost pressure is out of a predetermined range. Further, Japanese Patent Application Publication No. 06-229246 (JP-A-06-229246) describes a system that determines the forced air induction device as having an abnormality when the deviation of the actual boost pressure from the target boost pressure is large and a feedback correction amount, which is a correction amount used in controlling the opening and closing of a bypass passage, has continuously been at the limit on the positive side or at the limit on the negative side.

On the other hand, Japanese Patent Application Publication No. 05-248250 (JP-A-05-248250) describes a system that detects an abnormality of a control valve provided in a passage bypassing the forced air induction device based on the difference between the target intake air amount and the actual intake air amount. Further, Japanese Patent Application Publication No. 10-47071 (JP-A-10-47071) describes a system that detects an abnormality of a forced air induction device of a forced air induction system having an EGR valve based on the difference between the target EGR amount and the actual EGR amount.

In recent years, however, there have been increasing demands for better OBD (On-Board Diagnosis) systems and methods, such as those capable of detecting an abnormality of the forced air induction device even if the degree of the abnormality is low. According to the systems described in Japanese Patent No. 3738604 and Japanese Patent Application Publications No. 06-229246 and No. 05-248250, however, the operation state of the EGR valve (Exhaust Gas Recirculation Valve) is not taken into consideration when determining whether the forced air induction device has an abnormality, and therefore it is difficult to detect an abnormality of the forced air induction device when the degree of the abnormality is low, unlike when the degree of the abnormality is high. According to the system described in Japanese Patent Application Publication No. 10-47071, further, whether the forced air induction device has an abnormality can not be properly determined when the EGR valve has an abnormality.

### SUMMARY OF THE INVENTION

The invention provides a forced air induction system and a diagnosis method that, in a system in which an EGR valve is provided in parallel with a forced air induction device, enable more accurate diagnosis for the forced air induction device by taking the influence of the EGR valve into consideration.

The first aspect of the invention relates to a forced air induction system for an internal combustion engine, having: a forced air induction device; an EGR valve provided in an EGR passage connecting an intake air passage and an exhaust gas passage; and a diagnosis device adapted to execute an abnormality diagnosis for the forced air induction device based on a deviation of the actual boost pressure at the forced air induction device from a target boost pressure. The diagnosis device inhibits execution of the abnormality diagnosis when the operation state of the EGR valve is out of a normal operation range specifically determined.

The second aspect of the invention relates to an abnormality diagnosis method for a forced air induction system having: a forced air induction device; an EGR valve provided in an EGR passage connecting an intake air passage and an exhaust gas passage; and a diagnosis device adapted to execute an abnormality diagnosis for the forced air induction device. This method includes: determining whether a deviation of the actual boost pressure at the forced air induction device from a target boost pressure is equal to or larger than a reference value; determining whether the operation state of the EGR valve is normal; and executing the abnormality diagnosis for the forced air induction device if it is determined that the deviation is equal to or larger than the reference value and the operation state of the EGR valve is normal.

According to the forced air induction system and the diagnosis method described above, because the diagnosis device inhibits execution of the abnormality diagnosis for the forced air induction device when the operation state of the EGR valve is out of the normal operation range, the influence on the abnormality diagnosis from a deviation of the actual charging pressure from the target boost pressure that is caused by an abnormality of the EGR valve is minimized or eliminated, and therefore the forced air induction device can be diagnosed more accurately.

The operation state of the EGR valve may be determined as being out of the normal operation range when the deviation of the actual amount of an EGR gas supplied via the EGR valve from a target EGR amount is equal to or large than a reference value.

In this case, further, the forced air induction device may be determined as having an abnormality when the number of times a state where the operation state of the EGR valve is in the normal operation range and the deviation of the actual boost pressure at the forced air induction device from the target boost pressure is equal to or larger than a reference value has continued for a predetermined time has reached a reference number.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram showing the configuration of an abnormality diagnosis system for a forced air induction system according to an example embodiment of the invention; and

FIG. 2 is a flowchart illustrating the control procedure executed in the example embodiment of the invention.

### DETAILED DESCRIPTION OF THE EMBODIMENTS

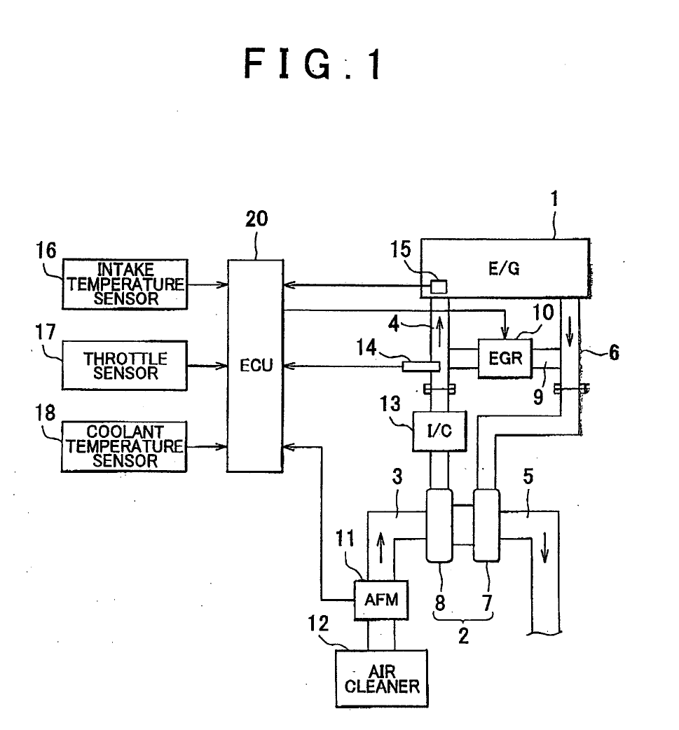

Hereinafter, an example embodiment of the invention will be described with reference to the drawings. Referring to FIG. 1, an engine 1 is an internal combustion diesel engine having a turbocharger 2. An intake passage 3 extending to the combustion chambers of the engine 1 includes an intake manifold 4, and an exhaust passage 5 extending from the combustion chambers includes an exhaust manifold 6. The turbocharger 2 is constituted of a turbine 7 provided in the exhaust passage 5 and a compressor 8 provided in the intake passage 3, and the compressor 8 is driven by the turbine 7.

The intake manifold 4 and the exhaust manifold 6 are in communication with each other via an EGR passage 9, and an EGR valve 10 is provided midway in the EGR passage 9. The opening degree of the EGR valve 10 is controlled using a solenoid (not shown). The EGR valve 10 is a poppet type valve. Note that the EGR valve 10 may alternatively be of other type, such as a butterfly type.

An airflow meter 11 is provided upstream of the turbocharger 2 in the intake passage 3, and the portion of the intake passage 3 upstream of the airflow meter 11 communicates with the outside via an air cleaner 12. An inter-cooler 13 is provided in the intake passage 3 to cool the intake air compressed by the compressor 8. An intake pressure sensor 14 is provided at the intake manifold 4 to detect the intake pressure. The portion of the exhaust passage 5 downstream of the turbocharger 2 communicates with the outside via a catalyst unit and a silencer, both not shown in the drawings.

The EGR valve 10 operates on the voltage applied from a battery, which is not shown in the drawings, and the operation of the EGR valve 10 is controlled by an electronic control unit (will be referred to as “ECU”) 20. The ECU 20 is constituted of a CPU (Central Processing Unit) as the main component of the ECU 20, a ROM (Read Only Memory) used to store various control programs, various control values, and so on, a RAM (Random Access Memory) used for various processing by the CPU, an output interface, and an input interface. The ECU 20 is adapted to control the EGR valve 10 in accordance with the state of operation by the driver and the running state.

The input interface of the ECU 20 is electrically connected to various sensors including the airflow meter 11, the intake pressure sensor 14, a crank angle sensor 15 provided near the crankshaft of the engine 1, an intake temperature sensor 16 used to detect the temperature of the intake manifold 4, a throttle sensor 17 used to detect the opening degree of a throttle valve, which is not shown in the drawings, a coolant temperature sensor 18 used to detect the temperature of the coolant of the engine 1. Based on the signals input from these sensors, the ECU 20 calculates respective detection values. On the other hand, the output interface of the ECU 20 is electrically connected to various actuators including fuel injection valves, which are not shown in the drawings, and the ECU 20 controls these actuators based on the results of various computations and calculations.

The ROM of the ECU 20 stores, other than the programs for the forced air induction device diagnosis according to the invention, various control programs on which a target fuel injection amount is calculated based on the opening degree of the throttle valve, the engine speed, etc., and fuel injection control is executed such that fuel of the target fuel injection amount is injected from each fuel injection valve.

The EGR valve 10 is controlled in accordance with a target EGR rate. The target EGR rate represents the ratio of the amount of the gas recirculated via the EGR valve 10 (will be referred to as “EGR amount”) to the total gas amount supplied to each combustion chamber. For example, the target EGR rate is calculated by dividing the EGR amount by the sum of the intake air amount and the EGR amount. The target EGR rate is predetermined as a function of the engine load and the engine speed in a map. The ECU 20 performs feedback control to the EGR valve 10 so as to minimize the absolute value of the deviation of the actual EGR rate from the target EGR rate.

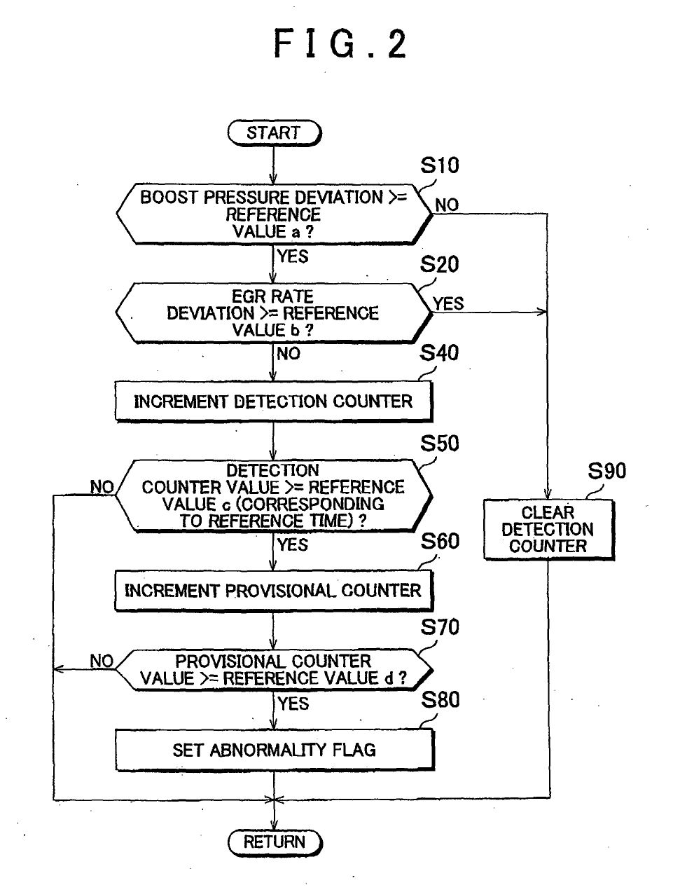

Next, the forced air induction device diagnosis procedure executed in the system configured as described above will be described with reference to FIG. 2. First, the ECU 20 determines whether the present boost pressure deviation is equal to or larger than a reference value a (e.g., 20 kPa) (Step S10). The boost pressure deviation is calculated by subtracting the value detected by the intake pressure sensor 14 from a target boost pressure. The target boost pressure is calculated by applying corresponding parameters (e.g., the target fuel injection amount, the engine speed, the intake temperature, the atmospheric pressure) to a given function or to a given map.

If “YES” has been obtained in step S10, the ECU 20 then determines whether an EGR rate deviation is equal to or larger than a reference value b (e.g., 0.1) (step S20). The EGR rate deviation is a parameter indicating whether the EGR valve is in a normal operation range and it is calculated by subtracting the actual EGR rate, which is estimated, from the target EGR rate. The target EGR rate is calculated as a function of the engine load and the engine speed, as mentioned earlier. The actual EGR rate is estimated by calculating the mass of intake gas based on the pressure in the intake manifold 4, which is detected by the intake pressure sensor 14, and then subtracting the intake air amount detected by the airflow meter 11 from the calculated mass of intake gas.

If “NO” has been obtained in step S20, that is, if the boost pressure deviation is equal to or larger than the reference value a and the EGR rate deviation is smaller than the reference valve b, the ECU 20 starts an abnormality diagnosis procedure. In this case, first, the ECU 20 increments a detection counter that is provided in the memory of the ECU 20 (step S40). The detection counter is incremented repeatedly until its value reaches a value c corresponding to a reference time (e.g., 1 second) (step S50).

If “YES” has been obtained in step S50, that is, when the state where the boost pressure deviation is equal to or larger than the reference value a and the EGR rate deviation is smaller than the reference valve b has continued for the reference time, the ECU 20 increments a provisional determination counter (step S60).

The provisional counter is incremented repeatedly until its value reaches a reference value d (e.g., 5) (step S70). When the value of the provisional counter has reached the reference value d, the ECU 20 then sets an abnormality flag to “1” (step S80) and then exits this routine. The abnormality flag is referenced in other control routines. For example, when the abnormality flag is “1”, execution of the boost pressure control is prohibited, and the abnormality is recorded in a diagnosis memory of the ECU 20 and the record is output to a maintenance technician during maintenance work.

On the other hand, in the case where the boost pressure deviation is smaller than the reference value a (step S10), or in the case where the boost pressure deviation is equal to or larger than the reference value a but the EGR rate deviation is equal to or larger than the reference value b (step S20), “NO” is obtained in step S10 or “YES” is obtained in step S20, and the detection counter is cleared (step S90). In this case, therefore, the abnormality diagnosis procedure for the turbocharger 2 (step S40 to step S80) is not executed.

As such, in this example embodiment, even when the boost pressure deviation is equal to or larger than the reference value a (step S10: YES), if the EGR valve is out of the normal operation range (step S20: YES), execution of the abnormality diagnosis procedure for the turbocharger 2 (step S40 to step S80) is inhibited. As such, in this example embodiment, the influence on the abnormality diagnosis of the turbocharger 2 from a deviation of the actual boost pressure from the target boost pressure that is caused by an abnormality of the EGR valve 10 is minimized or eliminated, and therefore the turbocharger 2 can be diagnosed more accurately.

In the foregoing example embodiment, the EGR valve 10 is determined to be out of the normal operation range when the deviation of the actual EGR amount from the target EGR amount is equal to or larger than the reference value, and therefore the aforementioned effect can be obtained with a simple structure.

In the foregoing example embodiment, further, because the provisional determination is made when the state where the operation state of the EGR valve 10 is in the normal operation range and the deviation of the actual boost pressure at the turbocharger 2 from the target boost pressure is equal to or larger than the reference value has continued for the predetermined time (step S50), it is possible to avoid erroneously detecting an abnormality of the turbocharger 2 from a momentary increase in the deviation of the actual boost pressure from the target boost pressure which often occurs in a transitional operation state, such as when an acceleration operation or a deceleration operation is being performed.

Further, in the foregoing example embodiment, because the turbocharger 2 is determined to have an abnormality when the number of times the provisional determination has been made has reached the reference value (step S70), the abnormality determination can be accurately made even in a state where the operation state of the engine frequently changes (e.g., so-called mode drive state), as well as in a state where the engine continues to run at a high speed and under a large load for a long period of time.

While the EGR rate deviation, which is calculated by subtracting the actual EGR rate from the target EGR rate, is used as the parameter indicating whether the EGR valve is in the normal operation range in the foregoing example embodiment, various other parameters, such as the drive current to the solenoid for actuating the EGR valve 10, may be used in combination to determine whether the EGR valve is in the normal operation range.

Further, while the reference values a, h, c, and d are fixed values in the foregoing example embodiment, they may alternatively be variable values that are variably set based on given operation conditions.

Further, while the invention is applied to the forced air induction system incorporating, as a forced air induction device, the turbocharger 2 that runs using the energy of exhaust gas in the foregoing example embodiment, the invention may be applied also to a forced air induction system incorporating a mechanical supercharger that runs on electric power, the drive power of the engine, etc., rather than the energy of exhaust gas. Further, while the invention is applied to the diesel engine in the foregoing example embodiment, the invention may be applied also to various other engines, such as gasoline engines, gaseous fuel engines, and so on. That is, the invention is intended to cover all such applications.

1-10. (canceled)

11. A forced air induction system for an internal combustion engine, comprising:
a forced air induction device;
an EGR valve provided in an EGR passage connecting an intake air passage and an exhaust gas passage; and
a diagnosis device adapted to execute an abnormality diagnosis for the forced air induction device based on a deviation of the actual boost pressure at the forced air induction device from a target boost pressure, wherein
the diagnosis device inhibits execution of the abnormality diagnosis when the operation state of the EGR valve is out of a normal operation range.

12. The forced air induction system according to claim 11, wherein:
the diagnosis device determines the forced air induction device as having an abnormality when the number of times a state where the operation state of the EGR valve is in the normal operation range and the deviation of the actual boost pressure at the forced air induction device from the target boost pressure is equal to or larger than a reference value has continued for a predetermined time has reached a reference number.

13. The forced air induction system according to claim 11, wherein:
the diagnosis device determines the operation state of the EGR valve as being out of the normal operation range when the deviation of the actual amount of an EGR gas supplied via the EGR valve from a target EGR amount is equal to or large than a reference value.

14. The forced air induction system according to claim 11, further comprising:
a controller that calculates the target boost pressure; and
an intake pressure sensor that detects an intake pressure at an intake manifold, wherein
the controller calculates the target boost pressure based on at least one of a target fuel injection amount for the internal combustion engine, the rotation speed of the internal combustion engine, an intake temperature, and an atmospheric pressure, and
the actual boost pressure is detected by the intake pressure sensor.

15. The forced air induction system according to claim 11, further comprising:
a controller that calculates the target EGR amount and the actual EGR amount;
an airflow meter that is provided in the intake air passage and that detects an intake air amount; and
an intake pressure sensor that detects an intake pressure at an intake manifold, wherein
the controller calculates the target EGR amount based on the load on the internal combustion engine and the rotation speed of the internal combustion engine, and
the controller calculates the actual EGR amount by subtracting the intake air amount from a mass of intake gas calculated based on the intake pressure.

16. The forced air induction system according to claim 11, wherein:
the forced air induction device includes a turbine provided in the exhaust gas passage and a compressor provided in the intake air passage and driven by the turbine.

17. A abnormality diagnosis method for a forced air induction system including: a forced air induction device; an EGR valve provided in an EGR passage connecting an intake air passage and an exhaust gas passage; and a diagnosis device adapted to execute an abnormality diagnosis for the forced air induction device, the method comprising:
determining whether a deviation of the actual boost pressure at the forced air induction device from a target boost pressure is equal to or larger than a reference value;
determining whether the operation state of the EGR valve is in a normal operation range; and
executing the abnormality diagnosis for the forced air induction device if it is determined that the deviation is equal to or larger than the reference value and the operation state of the EGR valve is in the normal operation range.

18. The abnormality diagnosis method according to claim 17, further comprising:
determining the forced air induction device as having an abnormality when the number of times a state where the operation state of the EGR valve is in the normal operation range and the deviation of the actual boost pressure at the forced air induction device from the target boost pressure is equal to or larger than the reference value has continued for a predetermined time has reached a reference number.

19. The abnormality diagnosis method according to claim 17, wherein:
the operation state of the EGR valve is determined as being in the normal operation range when the deviation of the actual amount of an EGR gas supplied via the EGR valve from a target EGR amount is smaller than a reference value.

20. The abnormality diagnosis method according to claim 17, wherein:
the forced air induction device includes a turbine provided in the exhaust gas passage and a compressor provided in the intake air passage and driven by the turbine.
